(19) United States
(12) Patent Application Publication
(10) Pub. No.: US 2026/0028228 A1
(43) Pub. Date: Jan. 29, 2026

(54) METHOD OF MANUFACTURING POSITIVE CATHODE MATERIAL AND LITHIUM-IRON-PHOSPHATE BATTERY

(71) Applicant: Feynman Energy Private Limited, Roorkee (IN)

(72) Inventor: Arun Kumar, Roorkee (IN)

(73) Assignee: Feynman Energy Private Limited, Roorkee, UK (IN)

(21) Appl. No.: 19/283,283

(22) Filed: Jul. 29, 2025

(30) Foreign Application Priority Data
Jul. 29, 2024 (IN) 202411057272

(51) Int. Cl. C01B 25/37; H01M 10/0525

(52) U.S. Cl. CPC C01B 25/375; H01M 10/0525; C01P 2002/02; C01P 2002/76; C01P 2002/82; C01P 2004/03; C01P 2004/04; C01P 2004/80; C01P 2006/40

(57) ABSTRACT

A method of manufacturing a positive cathode material with a stable olivine structure, including forming a mixture by combining lithium precursors, iron precursors, and phosphate precursors in an aqueous solution. The method further includes adding two different carbon sources to the mixture during mixing process and evaporating water from the mixture to form a homogeneous precursor mixture. The method further includes annealing the homogeneous precursor mixture to form a carbon-coated lithium iron phosphate cathode material with the stable olivine structure. The use of two different carbon sources in obtaining the carbon coating over lithium-iron-phosphate cathode material in an amorphous form, enhances the stability and performance of the cathode material resulting in an enhanced performance and longevity of rechargeable lithium-iron-phosphate batteries.

### CROSS-REFERENCE TO RELATED APPLICATIONS

This Patent Application makes reference to, claims the benefit of, and claims priority to an Indian Patent Application 202411057272, filed on Jul. 29, 2024, which is incorporated herein by reference in its entirely, and for which priority is hereby claimed under the Paris Convention and 35 U.S.C. 119 and all other applicable law.

The above-referenced applications are hereby incorporated herein by reference in their entirety.

### TECHNICAL FIELD

Certain embodiments of the disclosure relate to the field of cathode materials for a lithium-iron-phosphate battery. More specifically, certain embodiments of the disclosure relate to a method of manufacturing a positive cathode material with a stable olivine structure, a cathode material for a lithium-iron-iron-phosphate battery, and a lithium-iron-phosphate battery.

### BACKGROUND

Lithium secondary batteries have revolutionized the field of consumer electronics due to their lightweight nature and high energy density, attributes derived from lithium's strong reducing character. Among rechargeable battery systems, the lithium secondary batteries, particularly lithium-ion (Li-ion) configurations, are widely utilized. These systems typically consist of a positive electrode, commonly lithium cobalt oxide (LiCoO2), and a negative electrode, typically graphite, immersed in a liquid electrolyte, such as lithium hexafluorophosphate (LiPF6) in either ethylene carbonate (EC) or diethyl carbonate (DEC) or propylene carbonate (PC) that is EC/DEC/PC solvent. The materials used for the positive electrode have limitations in terms of stability, cost, and environmental impact. In recent years, three-dimensional structures using (XO4) n-polyanions, particularly lithium iron phosphate having the chemical formula of LiFePO4 (LFP) with an olivine structure, have emerged as promising alternatives for the positive electrode. The LFP cathode material offers several advantages, including an attractive operating potential of 3.5 V vs. Li+/Li, the use of abundant and environmentally friendly iron, and high thermal stability due to the strong P-O covalent bonds in its structure. However, the LFP cathode material has certain limitations related to its low electronic conductivity (e.g., σ˜10-9 S cm-1) and poor ionic conductivity in both of its lithiated (i.e., LiFePO4) and delithiated (i.e., FePO4) forms. These limitations result in poor rate capability and reduced capacity, especially at higher current densities. To address these issues, various approaches have been explored, including particle size reduction and carbon coating on the produced small particles.

Currently, certain attempts have been made to improve the performance of the LFP cathode material, such as producing very small particles and coating them with conductive carbon. For instance, few existing methods have shown that the carbon-coated LiFePO4 nanoparticles can significantly enhance capacity retention and cycling stability, achieving capacities of up to 160 mAh/g at a C rate for samples with 1 wt % carbon coating when cycled at 80° C. Other methods have provided capacities of 120 mAh/g at 5 C rate for carbon-coated LiFePO4 with particle sizes ranging from 100-200 nm. The existing manufacturing processes for LFP cathode material often involve solid-state methods, which can lead to the formation of bulky particles with limited surface area, making them suboptimal as cathode materials. Alternative methods like sol-gel and chemical routes have been explored, but challenges remain in achieving uniform particle size, consistent carbon coating, and optimal electrochemical performance. Thus, there exists a technical problem of how to manufacture a high-performance positive cathode material, as current manufacturing methods often result in large particle sizes and inconsistent carbon coating on the LFP cathode material, leading to suboptimal lithium-ion battery performance.

Further limitations and disadvantages of conventional and traditional approaches will become apparent to one of skill in the art through comparison of such systems with some aspects of the present disclosure as set forth in the remainder of the present application with reference to the drawings.

### SUMMARY

A method of manufacturing a positive cathode material with a stable olivine structure to enhance the performance of lithium-iron-phosphate batteries by improving the electrode capacity and cycling stability as shown in and/or described in connection with at least one of the figures, as set forth more completely in the claims.

These and other advantages, aspects, and novel features of the present disclosure, as well as details of an illustrated embodiment thereof, will be more fully understood from the following description and drawings.

### BRIEF DESCRIPTION OF DRAWINGS

Embodiments of the present disclosure will now be described, by way of example only, with reference to the following diagrams wherein:

FIG. 1 is a flowchart of a method of manufacturing a positive cathode material with a stable olivine structure, in accordance with an embodiment of the present disclosure;

FIG. 2 is a block diagram of a lithium-iron-phosphate battery, in accordance with an embodiment of the present disclosure;

FIG. 3A illustrates X-ray diffraction pattern of a carbon-coated lithium-iron-phosphate (LFP) cathode material in its pristine state, in accordance with an embodiment of the present disclosure;

FIG. 3B illustrates X-ray diffraction pattern of a carbon-coated LFP cathode material after a pre-defined number of charging and discharging cycles, in accordance with an embodiment of the present disclosure;

FIG. 4A illustrates Raman spectroscopy of a carbon-coated LFP cathode material in its pristine state, in accordance with an embodiment of the present disclosure;

FIG. 4B illustrates Raman spectroscopy of a carbon-coated LFP cathode material after a pre-defined number of charging and discharging cycles, in accordance with an embodiment of the present disclosure;

FIG. 5A illustrates Scanning Electron Microscopy (SEM) images of a carbon-coated LFP cathode material in its pristine state, in accordance with an embodiment of the present disclosure;

FIG. 5B illustrates SEM images of a carbon-coated LFP cathode material after a pre-defined number of charging and discharging cycles, in accordance with an embodiment of the present disclosure;

FIG. 6 illustrates Energy-Dispersive X-ray Spectroscopy (EDS) of a carbon-coated LFP cathode material, in accordance with an embodiment of the present disclosure;

FIG. 7 depicts a Transmission Electron Microscope (TEM) image of a carbon-coated LFP cathode material, in accordance with an embodiment of the present disclosure;

FIG. 8 is a graphical representation that depicts charging and discharging of a carbon-coated LFP cathode material, in accordance with an embodiment of the present disclosure;

FIG. 9 is a graphical representation that depicts cyclability of a carbon-coated LFP cathode material, in accordance with an embodiment of the present disclosure; and

FIG. 10 is a graphical representation that depicts cyclability tests at different scan rates of a carbon-coated LFP cathode material, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE EMBODIMENTS

The term “lithium precursors” refers to chemical compounds or substances that serve as a source of lithium ions in the synthesis or preparation of materials, such as lithium-ion battery cathodes.

The term “iron precursors” refers to chemical compounds or substances that serve as a source of iron ions in the synthesis or preparation of materials, such as iron-based catalysts or magnetic materials.

The term “phosphate precursors” refers to chemical compounds or substances that serve as a source of phosphate ions in the synthesis or preparation of materials, such as phosphate-based ceramics or phosphorus-containing compounds.

The term “aqueous solution” refers to a solution in which water is the solvent, typically containing one or more dissolved substances or solutes.

The term “carbon sources” refers to materials or substances that serve as a source of carbon atoms, which can be utilized in various processes such as the synthesis of carbon-based compounds or the formation of carbon coatings on cathode materials (e.g., the LFP cathode material).

The term “acetylene black” refers to a form of carbon material that is produced by thermal decomposition of acetylene gas, resulting in a highly porous and electrically conductive substance commonly used as an additive in various applications, including as a conductive filler in electrodes.

The term “sugar” refers to a class of carbohydrates that are typically sweet-tasting, soluble in water, and commonly found in various plants, serving as a source of energy and a building block for other organic compounds.

The term “homogenous carbon coating” refers to a uniform layer of carbon material that is evenly distributed on the surface of the LFP cathode material, providing consistent and continuous coverage.

The term “amorphous form” refers to a structure or state in which the atoms or molecules of a material are arranged in a disordered manner, lacking a regular crystalline pattern.

The term “homogeneous precursor mixture” refers to a substance or material that exhibits a uniform composition and distribution of its constituent elements or components, ensuring a consistent and even starting point for subsequent processes or reactions.

The term “annealing” refers to the process of heating a material to a specific temperature and then cooling it slowly to alter its physical and chemical properties, typically to relieve stress, improve crystalline structure, or enhance electrical conductivity.

The term “carbon-coated lithium iron phosphate cathode material” refers to a type of cathode material used in lithium-iron-phosphate batteries, where lithium iron phosphate particles are coated with a layer of carbon to improve conductivity and stability during charge and discharge cycles.

The term “uniform carbon-coated primary particles” refers to primary particles (i.e., Li, Fe and P particles) that have a consistent and even layer of carbon coating surrounding them.

The term “range of 2-15 nm” refers to a span of values between 2 and 15 nanometers.

The term “single-phase olivine structure” refers to a crystalline arrangement in which the cathode material exhibits a uniform composition and atomic arrangement, specifically adopting the olivine crystal structure.

The term “double amorphous carbon coating” refers to a protective layer consisting of two amorphous carbon layers that are applied onto the surface of the cathode material, providing enhanced stability and preventing degradation during electrochemical processes.

The term “X-ray diffraction (XRD)” refers to the phenomenon of X-rays interacting with a crystalline material, resulting in the scattering of the X-rays at specific angles, providing information about the crystal structure and lattice parameters.

The term “Bragg lines” refers to the distinct peaks observed in an XRD pattern, which correspond to constructive interference of X-rays scattered by the crystal lattice planes.

The term “pristine material” refers to a material in its original, unaltered state, without any modifications or impurities.

The term “reversible electrode capacity” refers to the maximum amount of charge that can be stored and released by an electrode during repeated charge and discharge cycles without significant degradation.

The term “theoretical capacity” refers to the maximum amount of charge that can be stored in an electrode material based on its chemical composition.

The term “cycled” refers to the process of repeatedly charging and discharging an electrochemical cell to evaluate its performance and stability.

The term “discharge rate” refers to the rate at which a cell or battery releases electrical energy during discharge.

The term “25° C.” refers to a temperature of 25 degrees Celsius, which is commonly used as a reference temperature in electrochemical studies and measurements.

The term “electrochemical performance” refers to the ability of a material or device to undergo electrochemical reactions efficiently and effectively.

The term “capacity loss” refers to the reduction in the ability of a battery or energy storage system to store and deliver electrical energy over time.

The term “charging” refers to the process of supplying electrical energy to a battery or energy storage system to restore its energy capacity.

The term “discharging” refers to the process of extracting electrical energy from a battery or energy storage system for use in an external circuit.

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

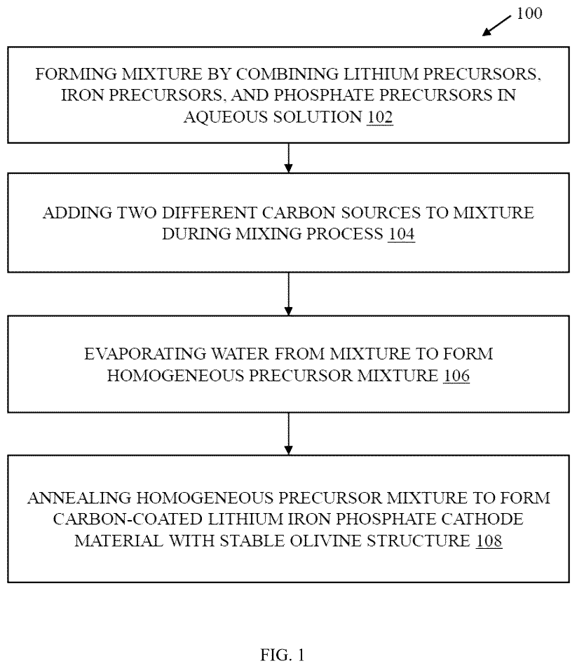

FIG. 1 is a flowchart of a method of manufacturing a positive cathode material with a stable olivine structure, in accordance with an embodiment of the present disclosure. With reference to FIG. 1, there is shown a method 100 of manufacturing a positive cathode material with a stable olivine structure. The method 100 includes steps 102 to 108.

There is provided the method 100 of manufacturing a positive cathode material with a stable olivine structure. The method 100 corresponds to a synthesis technique of the positive cathode material using components that may be dissolved in water to yield lithium-iron-phosphate, LiFePO4, (LFP) having controlled particle size, after decomposition and annealing under an inert or reducing temperature. The method 100 is used to form a carbon coating on the LFP cathode material having the stable olivine structure. The olivine structure is typically a stable structure due to P—O bonding. The carbon coating enhances the stability of the olivine structure by preventing direct contact of the cathode material with an electrolyte when used in a cathode of a lithium-iron-phosphate battery. Moreover, the carbon coating on the LFP cathode material increases the movement of lithium-ions in the electrolyte of the lithium-iron-phosphate battery, hence, improves the electric conductivity of the LFP cathode material.

At step 102, the method 100 includes forming a mixture by combining lithium precursors, iron precursors, and phosphate precursors in an aqueous solution. The mixing of the lithium precursors, iron precursors, and phosphate precursors in the aqueous solution is consistent at micro-level. The consistency of the mixture can be ensured either by use of a customized vessel or a customized reactor in which the mixing process can be carried out at a controlled temperature and a controlled pH value.

Furthermore, in an implementation scenario, for the preparation of the LFP cathode material, an aqueous solution of one molar (1M) Iron (II) oxalate heptahydrate (FeC2O4.7H2O) is slowly added under stirring in air to an equal quantity of a IM aqueous solution of Phosphoric Acid (H3PO4) at a pH between 5-8. This mixture is then slowly added to a 1M solution of Lithium Carbonate (Li2CO3) at a pH between 4-6. In the obtained mixture, the oxidation of ferrous iron (Fc2+) to ferric iron (Fe3+) is suppressed. If the mixture of iron and phosphate is obtained at the pH value below 5 or above 8 then, the precursor reaction results in precipitation, forming iron phosphate compounds in the ferric phase, which are not electrochemically active for battery applications.

At step 104, the method 100 further includes adding two different carbon sources to the mixture during the mixing process. In an implementation scenario, the two different carbon sources may be added in a ratio of 1:2 to the mixture during the mixing process. The two different carbon sources are added to the aforementioned mixture during the mixing process to achieve a homogenous carbon coating in an amorphous form on primary particles (e.g., Li, Fe and PO4 particles) of the olivine structure. The carbon coating enhances conductivity and shortens lithium transport within the cathode material, leading to improved capacity and excellent cyclability of the cathode material. The primary particles correspond to LiFePO4 particles without agglomeration.

Moreover, the “Carbon” used for coating over the LFP cathode material in the method 100, may include any sheet-like material that is substantially few atoms thick and formed from double bonded carbon atoms. The different sources of carbon may include, but are not limited to, carbon variations which are presently in existence as well as carbon variations which may be developed in future and may have compatibility with the LFP cathode materials.

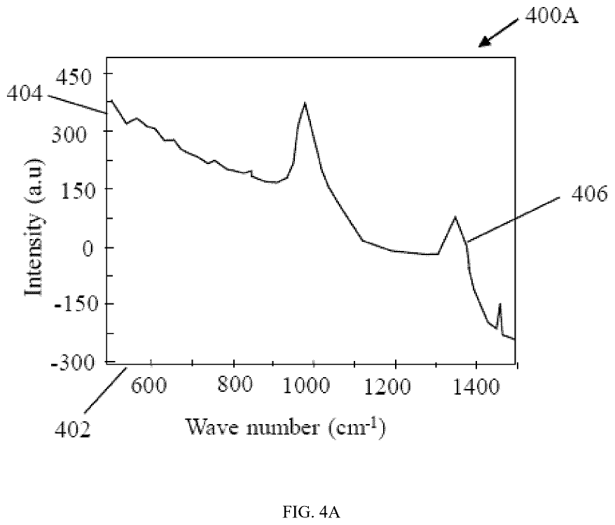

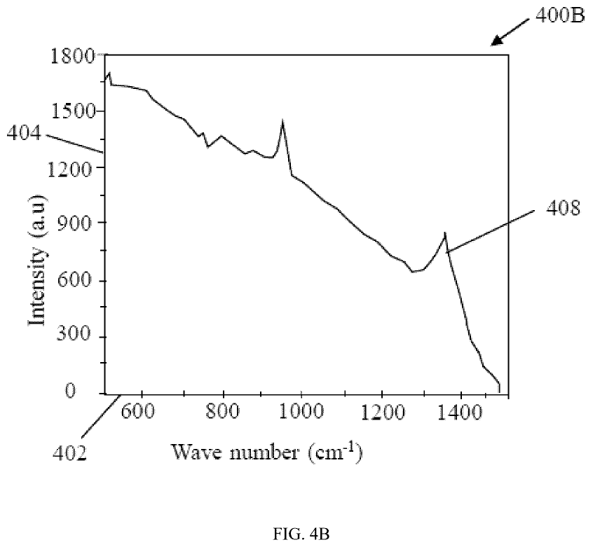

In accordance with an embodiment, the two different carbon sources comprise sugar and acetylene black. The utilization of sugar and acetylene black as two different carbon sources during the mixing process results in formation of the homogenous carbon coating in an amorphous form on the LFP cathode material. The carbon coating, along with the single-phase olivine structure, exhibits high thermal stability and prevents oxidation state changes during cycling. The presence of sp2 and sp3 carbon peaks confirmed by Raman spectroscopy further indicates the amorphous nature of the carbon, described and shown in detail, for example, in FIGS. 4A and 4B.

In accordance with an embodiment, the carbon-coated lithium iron phosphate cathode material comprises a homogenous carbon coating in an amorphous form. In an implementation scenario, the homogeneous carbon coating on the LFP cathode material may be achieved using a vessel or a customized reactor. The presence of the homogenous carbon coating in the amorphous form on the LFP cathode material improves electrochemical performance of an LFP battery by enhancing the stability of the cathode material during charge and discharge cycles. The homogenous carbon coating on the LFP cathode material increases the thermal stability of the cathode material, reducing the risk of thermal degradation. Additionally, the amorphous carbon coating prevents direct contact between the cathode material and the electrolyte, minimizing unwanted side reactions and improving the overall efficiency of the LFP battery.

At step 106, the method 100 further includes evaporating water from the mixture to form a homogeneous precursor mixture. The water slowly evaporated from the mixture in a known way between 80° C. and 175° C. in the air to produce the homogeneous precursor mixture containing Li, Fe, and P in the stoichiometric proportions of LiFePO4. The water is evaporated from the mixture to remove the solvent and create a solid mixture (i.e., the homogeneous precursor mixture). The formation of the homogeneous precursor mixture is required for obtaining positive cathode material with the stable olivine structure. The olivine structure is desirable as it offers improved performance and stability in lithium-iron-phosphate batteries. By evaporating the water, the precursor mixture becomes more uniform and facilitates subsequent reactions and transformations during the manufacturing process. Additionally, the controlled evaporation of water allows for precise control over the manufacturing process, resulting in a more reliable and reproducible production of the cathode material.

The two different carbon sources serve as reducing agents. The water is evaporated from the mixture by heating the mixture in the temperature range of 80 to 175° C. In an example, if the evaporation of water from the mixture is performed at high temperatures (temperatures higher than 175° C.), then, high-temperature reactions between the carbon sources and active particles (i.e., Li, Fe and PO4 particles) can lead to agglomeration, resulting in inconsistent particle morphology and non-uniform carbon coating.

At step 108, the method 100 further includes annealing the homogeneous precursor mixture to form a carbon-coated lithium iron phosphate cathode material with the stable olivine structure. The resulting homogeneous precursor mixture containing Li, Fe, and P in stoichiometric proportions is then subjected to annealing in a Nitrogen 1 reducing atmosphere with, for example, 10% H2 at a temperature of at least 550° C. for 5 to 15 hours to yield a pure crystalline LiFePO4 phase. The one or two intermediate grindings may be performed during annealing to ensure complete reduction of ferric iron (Fe3+) into ferrous iron (Fe2+). The final product obtained is a pure crystalline LiFePO4 phase with a stable olivine structure.

In an exemplary scenario, if the annealing is performed for more than 15 hours (e.g., 30 hours) that may lead to particle agglomeration, while the absence of an inert atmosphere during an annealing may result in the oxidation of ferrous iron (Fe2+) to ferric iron (Fe3+).

In another exemplary scenario, if the annealing is performed at a temperature higher than 550° C. (e.g., at 700° C.) then, several impurities may form however, some of these impurities can actually improve the conductivity of the olivine structure. Therefore, this process presents both challenges and opportunities for enhancing the overall performance of the carbon-coated LFP cathode material.

In accordance with an embodiment, the method 100 further comprises controlling particle size of the carbon-coated lithium iron phosphate cathode material using a formula based on power and time. The particle size of the carbon-coated lithium iron phosphate cathode material is controlled by utilizing the formula based on power and time. This formula calculates the amount of material required for optimization. The controlled particle size, achieved through the formula-based approach, results in a uniform and nano-sized carbon-coated particle distribution. This provides high conductivity and efficient lithium transport within the LFP cathode material.

In accordance with an embodiment, the carbon-coated lithium iron phosphate cathode material comprises uniform carbon-coated primary particles in the range of 2-15 nanometers (nm). Additionally, the two different carbon sizes are added as additives to achieve a uniform carbon coating on primary particles in the nano-range of 2-15 nm. The uniform carbon coating on primary particles in the nano-range provides high conductivity and prevents direct contact between the cathode material and electrolyte, minimizing side reactions. This further improves the electrochemical performance of the lithium-iron-phosphate battery. In a case, where no carbon coating is performed on primary particles (i.e., Li, Fe and P particles) of the cathode material, the primary particles have a tendency to react with the electrolyte and result in formation of larger particles, also referred to as secondary particles (or agglomerates), which is not desirable. Therefore, the carbon coating applied on the primary particles (i.e., Li, Fe and P particles) of the cathode material, prevents agglomeration of the primary particles.

In accordance with an embodiment, the annealing step results in a single-phase olivine structure with a double amorphous carbon coating. The single-phase olivine structure exhibits high thermal stability due to the covalent bond formed between phosphorus and oxygen (P—O bonding) and the prevention of direct contact with the electrolyte. The double amorphous carbon coating allows for the formation of homogeneously distributed LiFePO4 nanoparticles, while also preventing direct contact with the electrolyte and minimizing side reactions.

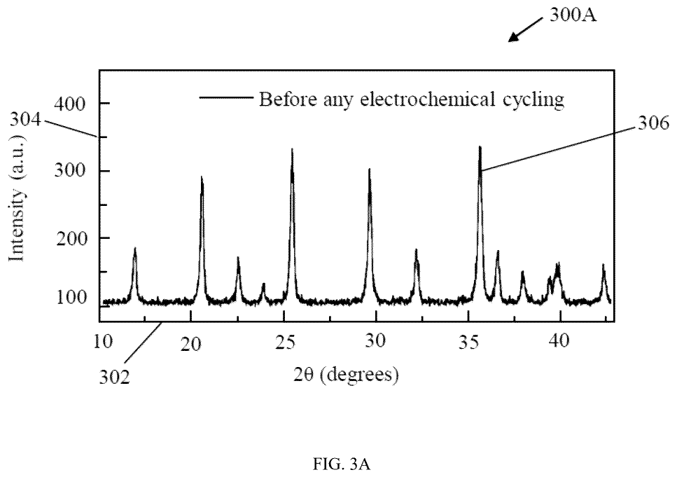

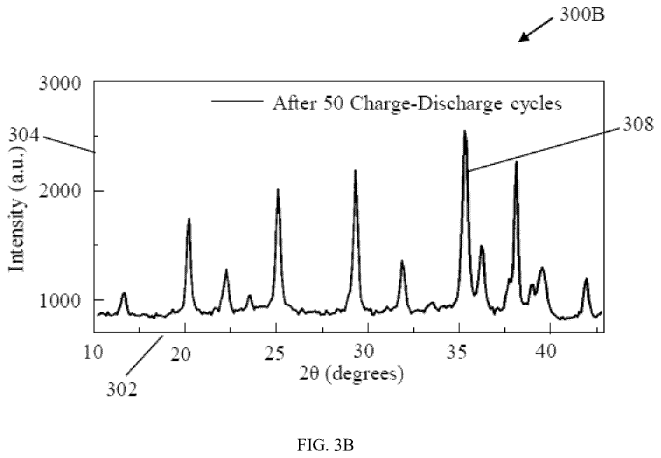

In accordance with an embodiment, the carbon-coated lithium iron phosphate cathode material maintains its olivine structure after cycling at room temperature, as evidenced by X-ray diffraction showing Bragg lines with the same intensity as that of a pristine material. The method 100 is used to examine the thermal stability and structural integrity of the olivine structure in the carbon-coated LFP cathode material after cycling at the room temperature (e.g., 25° C.). By examining the X-ray diffraction pattern, the presence of Bragg lines with the same intensity as that of the pristine material can confirm the maintenance of the olivine structure. The maintained olivine structure in the carbon-coated LiFePO4 cathode material after cycling at the room temperature is indicative of its high thermal stability. The thermal stability is attributed to the covalent bonding between phosphorus and oxygen (P—O) in the olivine structure, as well as the presence of the amorphous carbon coating that prevents direct contact with the electrolyte and minimizes side reactions. The maintained olivine structure contributes to the higher electrochemical performance and excellent capacity retention in the optimized electrode material. The X-ray diffraction (XRD) pattern of the carbon-coated LFP cathode material is shown and described, in detail, for example, in FIGS. 3A and 3B.

Thus, the method 100 is used for manufacturing the positive cathode material with the stable olivine structure for lithium-iron-phosphate batteries. The method 100 involves combining the lithium precursors, iron precursors, and phosphate precursors in the aqueous solution to form the mixture. During the mixing process, two different carbon sources (i.e., sugar and acetylene black) are added to the mixture. The water is then evaporated from the mixture to form the homogeneous precursor mixture, which is subsequently annealed to produce the carbon-coated lithium iron phosphate cathode material with the stable olivine structure. The cathode material consists of lithium iron phosphate particles with the amorphous carbon coating. The use of two different carbon sources in the formation of the amorphous carbon coating enhances the stability and performance of the cathode material. The advantages of this aspect include improved electrochemical performance, high thermal stability, and cost-effectiveness. The combination of the stable olivine structure and the amorphous carbon coating synergistically work together to prevent structural changes, enhance lithium-ion transport, and minimize side reactions, resulting in a cathode material with superior performance and longevity in lithium-iron-phosphate batteries. Moreover, the method 100 is cost-effective with minimum water and scalable for manufacturing large quantities of cathode materials.

The steps 102 to 108 are only illustrative, and other alternatives can also be provided where one or more steps are added, or one or more steps are provided in a different sequence without departing from the scope of the claims herein.

In one aspect, the present disclosure provides a cathode material for a lithium-iron-phosphate battery, comprising lithium iron phosphate particles and an amorphous carbon coating on the lithium iron phosphate particles leading to form a carbon-coated lithium iron phosphate cathode material, where the amorphous carbon coating is formed using two different carbon sources. The cathode material comprising the lithium iron phosphate particles and the amorphous carbon coating on the lithium iron phosphate particles leading to form a carbon-coating on the cathode material is performed using the method 100 (of FIG. 1). The carbon coating is amorphous in nature and achieved by use of the two different carbon sources, for example, sugar and acetylene black. The amorphous nature of the carbon coating is confirmed by X-ray diffraction and Raman spectroscopy. The carbon coating prevents direct contact between the cathode material and the electrolyte, minimizing side reactions and ensuring the stability of the crystal structure. The carbon coating also provides thermal stability to the cathode material. The synthesis process ensures a uniform and short reaction, resulting in a consistent product with a double amorphous carbon-coated lithium iron phosphate (C-LFP) cathode powder. The carbon coating is applied in the nano-range (e.g., 2-15 nm), which contributes to high conductivity and shortens lithium transport in the cathode, leading to high capacity and excellent cyclability. The uniform and short reaction during synthesis ensures consistent product quality and control over the carbon coating. The nano-sized carbon coating improves conductivity and facilitates efficient lithium transport within the cathode, resulting in high capacity and excellent cyclability of the battery.

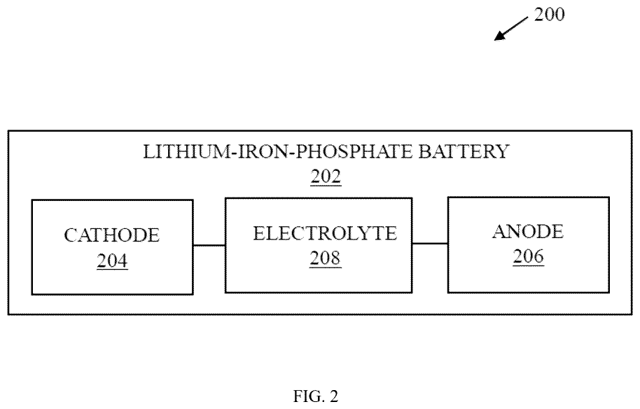

FIG. 2 is a block diagram of a lithium-iron-phosphate battery, in accordance with an embodiment of the present disclosure. FIG. 2 is described in conjunction with elements from FIG. 1. With reference to FIG. 2, there is shown a block diagram 200 of a lithium-iron-phosphate battery 202 comprising a cathode 204, an anode 206 and an electrolyte 208 between the cathode 204 and the anode 206.

The lithium-iron-phosphate battery 202 refers to a type of rechargeable battery that utilizes lithium iron phosphate as the cathode material, offering advantages such as high energy density, long cycle life, and improved safety characteristics.

The lithium-iron-phosphate battery 202 includes the cathode 204 that includes a carbon-coated lithium iron phosphate cathode material. The carbon coating is obtained using the method 100 that involves the use of two different carbon sources, have been described in detail, for example, in FIG. 1. The carbon coating is applied to the lithium iron phosphate cathode material to enhance the performance and stability of the lithium-iron-phosphate battery 202. The cathode 204 may also be referred to as a carbon coated cathode (3C).

There is provided the lithium-iron-phosphate battery 202 comprises the cathode 204 containing a carbon-coated lithium iron phosphate (C-LFP) material, the anode 206 and the electrolyte 208. The anode 206 is designed to allow intercalation or deposition of lithium ions (Li+), and the anode 206 can be made of lithium metal (Li), lithiated silicon, lithiated tin (Li4Ti5O12), lithium-containing oxides or sulfides, or other lithium-containing materials. The cathode 204, which is the positive electrode, consists of a stable olivine structure formed by combining LiFePO4 nanoparticles with amorphous carbon. The carbon coating ensures homogenous distribution of the nanoparticles. The term “electrolyte” refers to a substance or medium that allows the flow of ions between the electrodes (i.e., the cathode 204 and the anode 206) in an electrochemical cell. The electrolyte 208 can be made of materials, such as lithium trifuoromethane sulfonate (LiCF3SO3, 1 M) or other lithium salts, such as lithium bis (trifuoromethanesulfonyl) imide (LITFSI, 1 M)) dissolved in 1,3-dioxalane (DOL) and 1,2-dimethoxyethane (DME) (1:1, vol, or other solvents, such as tetra (ethylene glycol) dimethyl ether.

In an implementation scenario, the lithium-iron-phosphate battery 202 may also comprise a separator to electrically insulate the cathode 204 and the anode 206. In another implementation scenario, the separator may also be used as the electrolyte. The lithium-iron-phosphate battery 202 may also contain contacts, a casing, or wiring. In yet another implementation scenario, the lithium-iron-phosphate battery 202 may comprise more complex components, such as safety devices to prevent hazards if the battery overheats, or short circuits. The lithium-iron-phosphate battery 202 may be designed in traditional forms, such as coin cells or jelly rolls, or in more complex forms such as prismatic cells. The lithium-iron-phosphate battery 202 may contain more than one electrochemical cell, which may be connected in parallel, or in series as per requirement. The lithium-iron-phosphate battery 202 may be used in consumer electronics including cameras, cell phones, gaming devices, or laptop computers. The lithium-iron-phosphate battery 202 may also be used in much larger devices, such as electric automobiles, motorcycles, buses, delivery trucks, trains, or boats. Furthermore, the lithium-iron-phosphate battery 202 may have industrial uses, such as energy storage in connection with energy production, for instance, in a smart grid, or in energy storage for factories or health care facilities, for example, in the place of generators.

The cathode 204 exhibits a reversible electrode capacity of at least 85% of the theoretical capacity when cycled between 2.75 and 4.15 V vs. Li+/Li at a discharge rate of C/5 at 25° C. The cathode 204 is made using a powder with the chemical formula LiFePO4, which exhibits a reversible electrode capacity of at least 85% of the theoretical capacity. The cathode 204 is cycled between 2.70 and 4.15 V vs. Li+/Li at a discharge rate of C/5 at 25° C. The reversible electrode capacity of at least 85% ensures that the lithium-iron-phosphate battery 202 can efficiently store and release energy during cycling between 2.70 and 4.15 V vs. Li+/Li at the discharge rate of C/5 at 25° C.

In accordance with an embodiment, the cathode 204 exhibits a stable electrochemical performance with less than 3% capacity loss after 50th cycles of charging and discharging of the lithium-iron-phosphate battery 202. The use of amorphous double carbon coated lithium iron phosphate nanoparticles as the cathode material in the lithium-iron-phosphate battery 202 results in a stable electrochemical performance. The cathode 204 exhibits less than 3% capacity loss after 50 cycles of charging and discharging. This improved performance is attributed to the amorphous carbon coating, which prevents direct contact between the cathode 204 and the electrolyte 208, minimizing side reactions and maintaining the stability of the olivine structure.

The manufacturing of the carbon-coated LFP cathode material will now be described in detail with reference to examples.

### EXAMPLES

### General Method of Preparation

The positive cathode material (i.e., carbon-coated lithium-iron-phosphate (LFP) cathode material (C-LiFePO4, or C-LFP)) is manufactured by forming a mixture of lithium precursors, iron precursors, and phosphate precursors in an aqueous solution, adding two different carbon sources to the mixture during mixing process, evaporating water from the mixture to form a homogeneous precursor mixture and annealing the homogeneous precursor mixture.
Example 1: For the manufacturing of the positive cathode material (i.e., the carbon-coated LFP cathode material), an aqueous solution of 1M Iron (II) oxalate heptahydrate (FeC2O4.7H2O) is slowly added under stirring in air to an equal quantity of a IM aqueous solution of Phosphoric acid (H3PO4). This mixture is then slowly added to a 1M solution of Lithium Carbonate (Li2CO3). Thereafter, two different carbon sources, for example, sugar and acetylene black are added to the mixture. The water is slowly evaporated from the mixture by heating the mixture in a temperature range 80 to 175° C. to form a homogeneous precursor mixture, which is annealed in a Nitrogen 1 reducing atmosphere with, for example, 10% H2, at a temperature of at least 550° C. for 5 to 15 hours. The final product obtained is the carbon-coated LFP cathode material with the stable olivine structure having stability greater than a threshold value.
Example 2: For the manufacturing of the positive cathode material (i.e., carbon-coated LFP cathode material), an aqueous solution of 1M FeC2O4.7H2O is slowly added under stirring in air to an equal quantity of a IM aqueous solution of H3PO4 at a pH value of 8. This mixture is then slowly added to a IM solution of Li2CO3 at a pH value of 6. Thereafter, two different carbon sources, for example, sugar and acetylene black are added to the mixture in a ratio of, for example, 1:2. The water is slowly evaporated from the mixture by heating the mixture at a temperature of 175° C. to form a homogeneous precursor mixture, which is annealed in a Nitrogen 1 reducing atmosphere with, for example, 10% H2, at a temperature of at least 550° C. for 5 to 15 hours. The final product obtained is the carbon-coated LFP cathode material with the stable olivine structure having stability greater than a threshold value.
Example 3: For the manufacturing of the positive cathode material (i.e., the carbon-coated LFP cathode material), an aqueous solution of 1M FeC2O4.7H2O is slowly added under stirring in air to an equal quantity of a 1M aqueous solution of H3PO4 at a pH value of 5. This mixture is then slowly added to a 1M solution of Li2CO3 at a pH value of 4. Thereafter, two different carbon sources, for example, sugar and acetylene black are added to the mixture. The water is slowly evaporated from the mixture by heating the mixture at a temperature of 80° C. to form a homogeneous precursor mixture, which is annealed in a Nitrogen 1 reducing atmosphere with, for example, 10% H2, at a temperature of at least 550° C. for 5 to 15 hours. The final product obtained is the carbon-coated LFP cathode material with the stable olivine structure having stability greater than a threshold value.
Example 4: For the manufacturing of the positive cathode material (i.e., the carbon-coated LFP cathode material), an aqueous solution of 1M FeC2O4.7H2O is slowly added under stirring in air to an equal quantity of a IM aqueous solution of H3PO4 at a pH value of 6. This mixture is then slowly added to a 1M solution of Li2CO3 at a pH value of 5. Thereafter, two different carbon sources, for example, sugar and acetylene black are added to the mixture in a ratio of, for example, 1:2. The water is slowly evaporated from the mixture by heating the mixture at a temperature of 125° C. to form a homogeneous precursor mixture, which is annealed in a Nitrogen 1 reducing atmosphere with, for example, 10% H2, at a temperature of at least 550° C. for 5 to 15 hours. The final product obtained is the carbon-coated LFP cathode material with the stable olivine structure having stability greater than a threshold value.

### RESULTS

The results described in the following figures correspond to the positive cathode material (i.e., the carbon-coated LFP cathode material), manufactured according to any of aforementioned preparation examples, or as described in FIGS. 1 and 2.

Now, referring to FIG. 3A, there is shown X-ray diffraction pattern of a carbon-coated lithium-iron-phosphate (LFP) cathode material in its pristine state, in accordance with an embodiment of the present disclosure. With reference to FIG. 3A, there is shown a graphical representation 300A that includes an X-axis 302 that represents the angle (i.e., 2θ) between incident X-ray beam and detector measuring the diffracted X-rays in degrees. There is further shown a Y-axis 304 that represents intensity of diffracted X-rays in arbitrary units (au). Furthermore, there is shown an X-ray diffraction pattern 306 of carbon-coated LFP cathode material in its pristine state (means no electrochemical cycle has been performed yet). The carbon-coated LFP cathode material is obtained by use of the method 100 (of FIG. 1). The cathode material is considered in a powder form and annealed at 550° C. The diffraction peaks are indexed in the orthorhombic space group Pnma of the olivine structure of the cathode material (LiFePO4), with unit-cell parameters of a=6.004 Å, b=10.326 Å, and c=4.691 Å. The powder is characterized by an average particle size of about 100-500 nm and by a specific surface of less than 0.6 m2/g.

The cathode material may be used in a powder form, having the chemical formula of LiFePO4, for lithium secondary batteries. Alternatively, may be stated that the LiFePO4 powder may be used effectively as the positive electrode in an electrochemical cell. Before the cell realization, an intimate mixture of LiFePO4 and conducting carbon, preferably acetylene black or Carbon Super P, is produced. To this end, LiFePO4 and carbon are introduced in the commonly used weight ratio of 90/10 in a stainless-steel vessel, preferably filled with Argon (Ar), and ball milled for an adequate time with a milling apparatus. The LiFePO4 particles are hereby coated with conductive carbon. The addition of a binder for cell operation is not mandatory.

Referring to FIG. 3B, there is shown X-ray diffraction pattern of a carbon-coated lithium-iron-phosphate (LFP) cathode material after a pre-defined number of charging and discharging cycles, in accordance with an embodiment of the present disclosure. FIG. 3B is described in conjunction with FIG. 3A. With reference to FIG. 3B, there is shown a graphical representation 300B that includes the X-axis 302 and the Y-axis 304. Furthermore, there is shown an X-ray diffraction pattern 308 of a carbon-coated LFP cathode material after a pre-defined number of charging and discharging cycles (e.g., 50 cycles). The X-ray diffraction pattern 308 of FIG. 3B appears similar to the X-ray diffraction pattern 306 of FIG. 3A that means there is no material degradation in the carbon-coated LFP cathode material (when manufactured with the method of the present invention) after so many electrochemical cycles (i.e., the charging and discharging cycles) and therefore, the carbon-coated LFP cathode material exhibits the similar X-ray diffraction pattern as that of its pristine state. This further indicates the stability of the olivine structure maintained by the carbon-coated LFP cathode material. Moreover, the similarity between the X-ray diffraction pattern 308 of FIG. 3B and the X-ray diffraction pattern 306 of FIG. 3A indicates that there is no change in cathode material and hence, there is no change in oxidation state of the cathode material resulting in stability of olivine structure of the carbon coated LFP cathode material. Additionally, the similarity between the X-ray diffraction pattern 308 of FIG. 3B and the X-ray diffraction pattern 306 of FIG. 3A indicates the lithium transportation in one dimension (001) resulting in an enhanced ionic conductivity of the carbon coated LFP cathode material.

Referring to FIG. 4A, there is shown Raman spectroscopy of a carbon-coated LFP cathode material in its pristine state, in accordance with an embodiment of the present disclosure. With reference to FIG. 4A, there is shown a graphical representation 400A that includes an X-axis 402 that represents Raman shifts in wave numbers (cm-1). There is further shown a Y-axis 404 that represents intensity of scattered light in arbitrary units (au). Furthermore, there is shown a first curve 406 that represents carbon peaks (sp2 and sp3) in Raman spectroscopy of carbon-coated LFP cathode material in its pristine state (means no electrochemical cycle has been performed yet).

Referring to FIG. 4B, there is shown Raman spectroscopy of a carbon-coated LFP cathode material after a pre-defined number of charging and discharging cycles, in accordance with an embodiment of the present disclosure. FIG. 4B is described in conjunction with FIG. 4A. With reference to FIG. 4B, there is shown a graphical representation 400B that includes the X-axis 402 and the Y-axis 404. Furthermore, there is shown a second curve 408 that represents carbon peaks (sp2 and sp3) in Raman spectroscopy of carbon-coated LFP cathode material after a pre-defined number of charging and discharging cycles (e.g., 50 cycles). The presence of carbon peaks (sp2 and sp3) in both the first curve 406 and the second curve 408 indicates that there is no material degradation in the carbon-coated LFP cathode material (when manufactured as per the method of the present invention) after so many electrochemical cycles (i.e., the charging and discharging cycles) and therefore, the carbon-coated LFP cathode material exhibits the similar Raman spectroscopy with carbon peaks as that obtained when the carbon-coated LFP cathode material is used in its pristine state. Moreover, the presence of carbon peaks (sp2 and sp3) in both the first curve 406 and the second curve 408 confirms the amorphous form of the carbon coating of the LFP cathode material. FIGS. 4A and 4B also depict that no major additional crystalline carbon peaks are observed in Raman spectroscopy of the carbon-coated LFP cathode material.

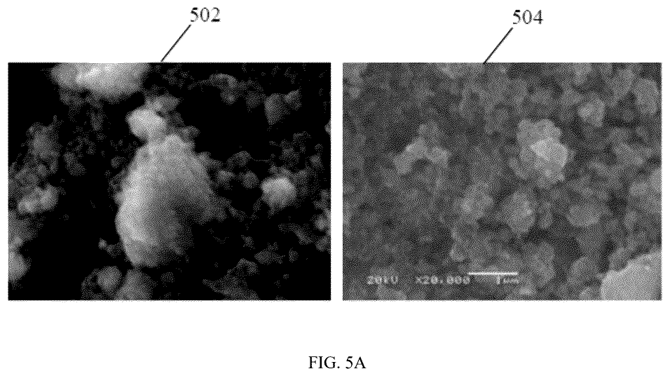

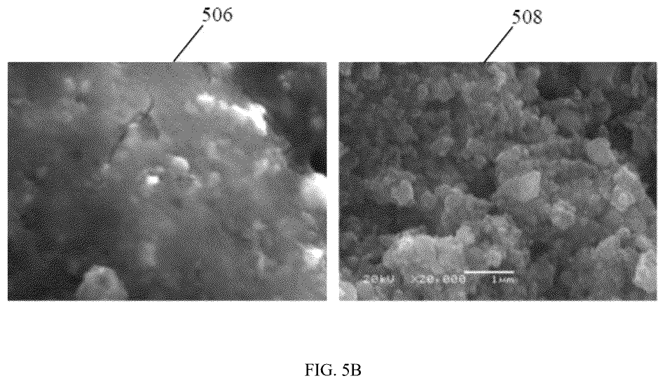

Referring to FIG. 5A, there are shown Scanning Electron Microscopy (SEM) images of a carbon-coated LFP cathode material in its pristine state, in accordance with an embodiment of the present disclosure. With reference to FIG. 5A, there is shown a first SEM image 502 and a second SEM image 504. Each of the first SEM image 502 and the second SEM image 504 corresponds to SEM images of a carbon-coated LFP cathode material in its pristine state.

Referring to FIG. 5B, there are shown SEM images of a carbon-coated LFP cathode material after a pre-defined number of charging and discharging cycles, in accordance with an embodiment of the present disclosure. FIG. 5B is described in conjunction with FIG. 5A. With reference to FIG. 5B, there is shown a third SEM image 506 and a fourth SEM image 508. Each of the third SEM image 506 and the fourth SEM image 508 corresponds to SEM images of a carbon-coated LFP cathode material (when manufactured as per the method of the present invention) after a pre-defined number of charging and discharging cycles (e.g., 50 cycles).

In an exemplary implementation scenario, the electrochemical characteristics of the carbon coated LFP cathode material are evaluated in coin cells with lithium metal pasted on a nickel foil as the negative electrode and lithium hexafluorophosphate (LiPF6) in 1 mole as the electrolyte. The electrochemical characteristics of LiFePO4 as a function of the charge and discharge rate and of the temperature are evaluated. In order to examine the electrode morphology, several cells are built which are analyzed in pristine state and after the 50th electrochemical cycle, using SEM images.

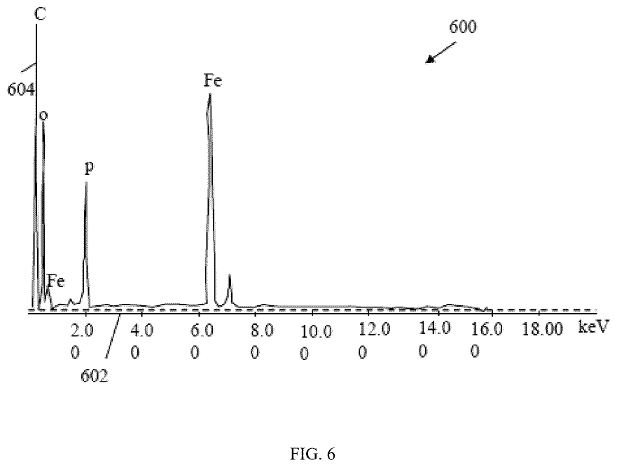

Referring to FIG. 6, there is shown Energy-Dispersive X-ray Spectroscopy (EDS) of a carbon-coated LFP cathode material, in accordance with an embodiment of the present disclosure. With reference to FIG. 6, there is shown an EDS spectrum 600 of a carbon-coated LFP cathode material (when manufactured as per the method of the present invention). The EDS spectrum 600 includes an X-axis 602 that represents energy in kilo-electron volts (keV) and a Y axis 604 that represents intensity in arbitrary units (au). There is further shown characteristic peaks for each clement, for example, carbon (C), oxygen (O), iron (Fe), phosphorus (P), at specific energy values, in the EDS spectrum 600. The EDS spectrum 600 can be used to verify the presence and relative amounts of C, Li, Fc, P, and O in the carbon-coated LFP cathode material and detect any impurities or dopants. The EDS spectrum 600 can also be used to analyze the distribution of carbon in the carbon-coated LFP cathode material and examine changes in elemental composition after electrochemical cycling of the lithium-iron-phosphate battery 202.

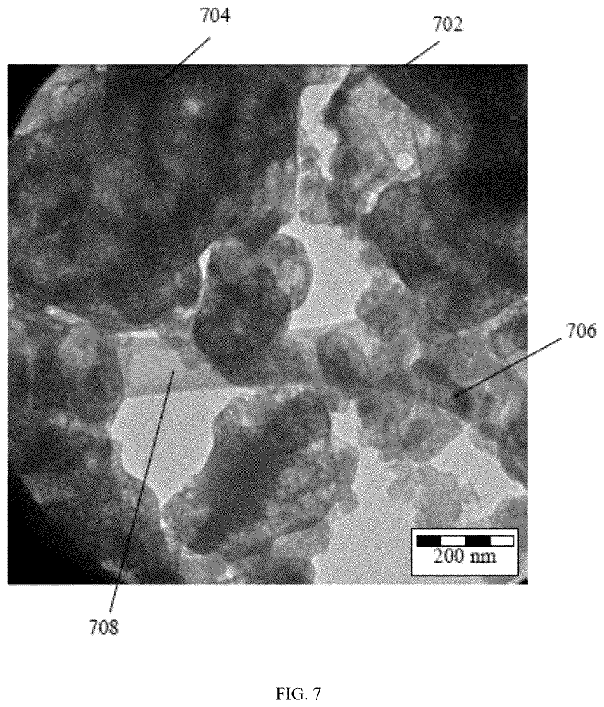

Referring to FIG. 7, there is shown a Transmission Electron Microscope (TEM) image of a carbon-coated LFP cathode material, in accordance with an embodiment of the present disclosure. With reference to FIG. 7, there is shown a TEM image 702 of a carbon-coated LFP cathode material (when manufactured as per the method of the present invention). The TEM image 702 represents a highly magnified view of an internal structure of the carbon-coated LFP cathode material either at nanoscale (e.g., 200 nanometer (nm) or 0.1 micrometer (μm)) or at atomic level. The TEM image 702 includes dark areas 704 as well as light areas 706, where the dark areas 704 represent regions of high electron scattering or absorption and the light areas 706 represent regions of low electron scattering or absorption. The TEM image 702 also includes lattice fringes 708 which are regularly spaced lines representing atomic planes in crystalline materials. The TEM image 702 may be used to visualize nanoparticle size and shape of the carbon-coated LFP cathode material and examine crystal structure and any defects present in the carbon-coated LFP cathode material. The TEM image 702 may also be used to examine interfaces between different materials, for example, the carbon coating on LiFePO4 particles and investigate structural changes after battery cycling.

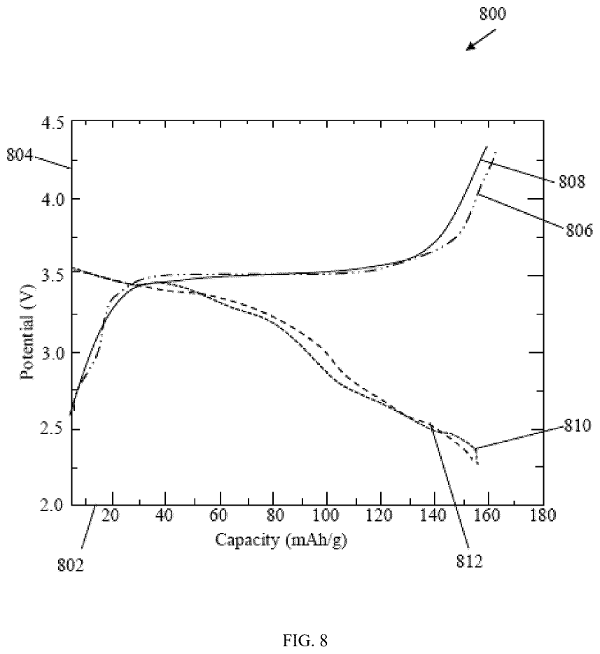

Referring to FIG. 8, there is shown a graphical representation that depicts charging and discharging of a carbon-coated LFP cathode material, in accordance with an embodiment of the present disclosure. With reference to FIG. 8, there is shown a graphical representation 800 that includes an X-axis 802 representing capacity of a carbon-coated LFP cathode material in mAh/g (when manufactured as per the method of the present invention) and a Y axis 804 representing potential in volts (V) of the carbon-coated LFP cathode material.

With respect to the graphical representation 800, there is further shown a first curve 806 representing a first charging cycle and a second curve 808 representing a 50th charging cycle of the carbon-coated LFP cathode material. Furthermore, there is shown a third curve 810 representing a first discharging cycle and a fourth curve 812 representing a 50th discharging cycle of the carbon-coated LFP cathode material. As shown in FIG. 8, the first curve 806 and the second curve 808 seems approximately similar to each other which means that the carbon-coated LFP cathode material exhibits the same properties in the 50th charging cycle (i.e., the second curve 808) as exhibited in the first charging cycle (i.e., the first curve 806). Additionally, the third curve 810 and the fourth curve 812 are also approximately similar to each other which means that the carbon-coated LFP cathode material exhibits the same discharging pattern in the 50th cycle as well as in the first cycle. This further signifies that there are not any structural changes in the carbon-coated LFP cathode material when subjected to so many charging and discharging cycles hence, using the carbon-coated LFP cathode material enhances the battery life significantly.

Moreover, from the FIG. 8, this is also observed that the carbon-coated LFP cathode material behaves very well at a high charge and discharge rate of C/5, i.e., one lithium is extracted or inserted within 5 hours. The carbon-coated LFP cathode material achieves a significantly improved capacity retention, for example, 93% of theoretical value of 170 mAh/g is observed in the FIG. 8, which equals a reversible electrode capacity of 154 mAh/g (when manufactured as per the method of the present invention).

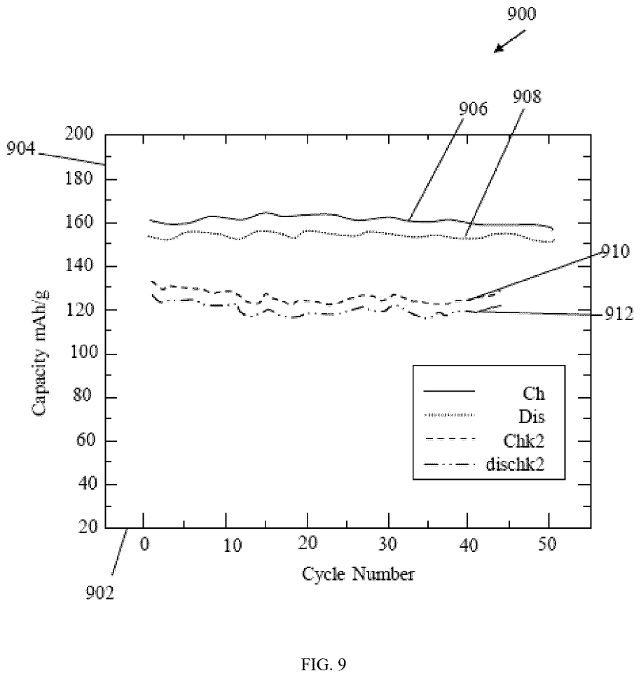

Referring to FIG. 9, there is shown a graphical representation that depicts the cyclability of a carbon-coated LFP cathode material, in accordance with an embodiment of the present disclosure. With reference to FIG. 9, there is shown a graphical representation 900 that includes an X-axis 902 representing cycle number of a carbon-coated LFP cathode material (when manufactured as per the method of the present invention) and a Y axis 904 representing capacity of the carbon-coated LFP cathode material in mAh/g.

With respect to the graphical representation 900, there is further shown a first curve 906 representing a charging cycle and a second curve 908 representing a discharging cycle of the carbon-coated LFP cathode material. Furthermore, there is shown a third curve 910 representing another charging cycle and a fourth curve 912 representing another discharging cycle of the carbon-coated LFP cathode material.

Additionally, the electrochemical cells comprising the cathode of the carbon-coated LFP cathode material are evaluated at different charging and discharging rates and after 45th electrochemical cycle (i.e., charging and discharging cycle), the same charging and discharging rate is repeated as stated from initially 100% to recover the initial value, which shows a highly stable structure of carbon-coated LFP cathode material.

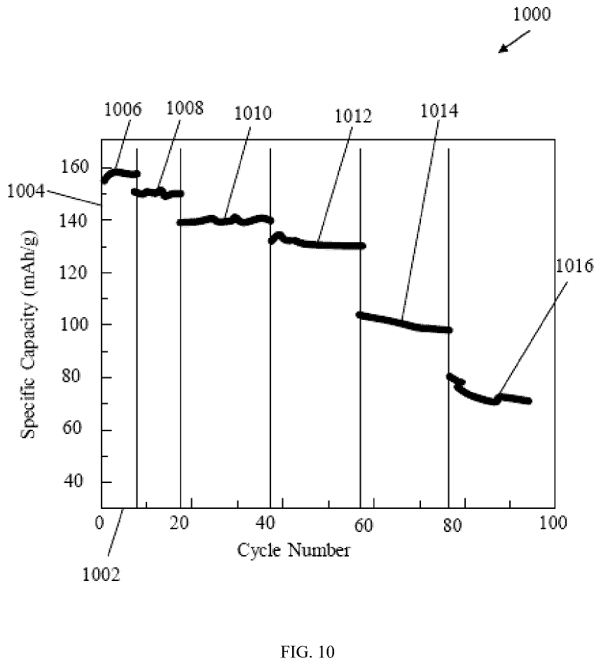

Referring to FIG. 10, there is shown a graphical representation that depicts cyclability tests at different scan rates of a carbon-coated LFP cathode material, in accordance with an embodiment of the present disclosure. With reference to FIG. 10, there is shown a graphical representation 1000 that includes an X-axis 1002 representing cycle number of a carbon-coated LFP cathode material (when manufactured as per the method of the present invention) and a Y axis 1004 representing specific capacity of the carbon-coated LFP cathode material in mAh/g.

With respect to the graphical representation 1000, there is further shown a plurality of curves obtained at different charge and discharge rates, for example, a first curve 1006 is obtained at a charge and discharge rate of C/10, a second curve 1008 is obtained at a charge and discharge rate of C/5, a third curve 1010 is obtained at a charge and discharge rate of C/2.5, a fourth curve 1012 is obtained at a charge and discharge rate of C/1.3, a fifth curve 1014 is obtained at a charge and discharge rate of 2 C and a sixth curve 1016 is obtained at a charge and discharge rate of 4 C. As shown in the FIG. 10, the cycling is performed at the charge and discharge rate of C/10. A number of tests have been conducted at the charge and discharge rate of C/10 which show the high stability of carbon-coated LFP cathode material, even when having a long electrochemical cycle.

Furthermore, this is demonstrated that the carbon-coated LFP cathode material with smaller particle size (in nanometer range of 2-15) provides the easy pathways for Li-ion at cathode, which results in an improved electrochemical response of the lithium-iron-phosphate battery 202.

For the preparation of the positive cathode material (i.e., the carbon-coated lithium-iron-phosphate (LFP) cathode material), the mixture of iron and phosphate is tested at different pH values, as shown in Table 1. The mixture of iron and phosphate is further added to a lithium source, which is also tested at different pH values. Later, two different carbon sources, for example, sugar and acetylene black are added to the mixture and water is evaporated from the mixture at different temperature values and then subjected to annealed in a Nitrogen I reducing atmosphere with, for example. 10% H2. at a temperature of at least 550° C. for a specific time duration.

### EXPERIMENTAL DATA

TABLE 1

| Cycle | Ch- Capacity | Disch - Capacity |
|---|---|---|
| Number | (mAh/g) | (mAh/g) |
| 1 | 158.889 | 155.834 |
| 2 | 158.055 | 155 |
| 3 | 157.222 | 154.445 |
| 4 | 157.222 | 155.56 |
| 6 | 159.44 | 157.226 |
| 7 | 160.554 | 157.78 |
| 8 | 161.388 | 157.033 |
| 9 | 160.554 | 156.11 |
| 10 | 160.56 | 155.55 |
| 11 | 159.45 | 154.726 |
| 12 | 159.16 | 155.55 |
| 13 | 161.11 | 157.508 |
| 14 | 163.55 | 158.615 |
| 15 | 163.6 | 158.34 |
| 15 | 162.5 | 157.94 |
| 16 | 161.11 | 156.83 |
| 17 | 160.22 | 155 |
| 18 | 159.62 | 154.72 |
| 19 | 160 | 156.95 |
| 20 | 162.22 | 158.33 |
| 21 | 162.5 | 158.34 |
| 22 | 162.5 | 157.77 |
| 23 | 161.39 | 156.66 |
| 24 | 160.9 | 155.59 |
| 25 | 159.88 | 155.28 |
| 26 | 158.61 | 156.28 |
| 27 | 159.45 | 157.22 |
| 28 | 161.39 | 158.05 |
| 29 | 161.11 | 157.5 |
| 30 | 160.27 | 156.97 |
| 31 | 159.69 | 156.27 |
| 32 | 158.97 | 155.37 |
| 33 | 158.27 | 154.21 |
| 34 | 157.22 | 155.28 |
| 35 | 158.61 | 156.39 |
| 36 | 159.44 | 156.94 |
| 37 | 158.62 | 156.82 |
| 38 | 158.38 | 155.92 |
| 39 | 158.06 | 154.44 |
| 40 | 157.95 | 154.39 |
| 41 | 157.09 | 154.31 |
| 42 | 156.95 | 155.27 |
| 43 | 156.82 | 156.38 |
| 44 | 157 | 156.38 |
| 45 | 157.09 | 155.86 |
| 47 | 157.93 | 154.71 |
| 48 | 157.03 | 153.41 |
| 49 | 156.96 | 153.22 |
| 50 | 155 | 152.89 |
| 51 | 156.02 | 152.03 |
| 52 | 157.56 | 152.76 |
| 52 | 158.21 | 154.11 |
| 53 | 157.79 | 153.09 |
| 55 | 157.31 | 152.78 |
| 56 | 157.06 | 153.89 |
| 58 | 157.78 | 153.01 |
| 59 | 156.67 | 152.89 |
| 60 | 156.76 | 153 |
| 61 | 156.9 | 153.78 |
| 62 | 157.34 | 152.98 |
| 63 | 156.41 | 153.15 |
| 65 | 156.23 | 152.89 |
| 67 | 156.61 | 152.62 |
| 68 | 157.12 | 153.38 |
| 69 | 157.56 | 153.23 |
| 70 | 156.79 | 153.45 |
| 71 | 157.81 | 154.31 |
| 72 | 157.36 | 153.43 |
| 73 | 157.28 | 153.29 |
| 74 | 155.67 | 152.48 |
| 75 | 157.64 | 154 |
| 76 | 158.34 | 153.67 |
| 77 | 157.9 | 153.27 |
| 78 | 157 | 153.3 |
| 79 | 157.61 | 152.56 |
| 80 | 156.51 | 153.15 |

The above-mentioned TABLE 1 is derived from comprehensive testing of 76 cycles, with 100% of all cycles maintaining above 85% of theoretical capacity, demonstrating exceptional consistency and reliability. The initial discharge capacity begins at 155.834 mAh/g, representing 91.67% of the theoretical maximum (170 mAh/g). The high performance is not merely an initial phenomenon but is maintained consistently throughout the entire testing period. Even after 76 cycles, the discharge capacity remains at 153.67 mAh/g (90.39% of theoretical), demonstrating remarkable stability. Moreover, the average discharge capacity across all cycles is 155.05 mAh/g, which corresponds to 91.20% of the theoretical capacity significantly exceeding our claimed threshold of 85%. Even at the lowest point (cycle 51), the discharge capacity never falls below 152.03 mAh/g (89.43% of theoretical), maintaining a comfortable margin above the claimed minimum. The maximum capacity reached 158.62 mAh/g (93.30% of theoretical), demonstrating the exceptional potential of our dual carbon coating approach.

Further, after 50 cycles, the cathode battery of the present invention retains 98.11% of its initial capacity, representing only a 1.89% capacity loss. Moreover, such exceptional retention rate significantly outperforms the “less than 3% capacity loss” and stands in stark contrast to conventional LFP materials, which typically exhibit 5-10% capacity loss over similar cycling periods. Additionally, the conventional LFP materials typically deliver 70-85% of theoretical capacity, while our material consistently performs above 89% throughout all cycles. The minimal capacity fades and exceptional consistency across extended cycling.

Modifications to embodiments of the present disclosure described in the foregoing are possible without departing from the scope of the present disclosure as defined by the accompanying claims. Expressions such as “including,” “comprising,” “incorporating,” “have,” “is” used to describe, and claim the present disclosure are intended to be construed in a non-exclusive manner, namely allowing for items, components, or elements not explicitly described also to be present. Reference to the singular is also to be construed to relate to the plural. The word “exemplary” is used herein to mean “serving as an example, instance, or illustration.”

While various embodiments described in the present disclosure have been described above, it should be understood that they have been presented by way of example, and not limitation. It is to be understood that various changes in form and detail can be made therein without departing from the scope of the present disclosure. In addition to using hardware (e.g., within or coupled to a central processing unit (“CPU”), microprocessor, micro controller, digital signal processor, processor core, system on chip (“SOC”) or any other device), implementations may also be embodied in software (e.g. computer readable code, program code, and/or instructions disposed in any form, such as source, object or machine language) disposed for example in a non-transitory computer-readable medium configured to store the software. Such software can enable, for example, the function, fabrication, modeling, simulation, description and/or testing of the apparatus and methods describe herein. For example, this can be accomplished through the use of general program languages (e.g., C, C++), hardware description languages (HDL) including Verilog HDL, VHDL, and so on, or other available programs. Such software can be disposed in any known non-transitory computer-readable medium, such as semiconductor, magnetic disc, or optical disc (e.g., CD-ROM, DVD-ROM, etc.). The software can also be disposed as computer data embodied in a non-transitory computer-readable transmission medium (e.g., solid state memory any other non-transitory medium including digital, optical, analog-based medium, such as removable storage media). Embodiments of the present disclosure may include methods of providing the apparatus described herein by providing software describing the apparatus and subsequently transmitting the software as a computer data signal over a communication network including the internet and intranets.

It is to be further understood that the system described herein may be included in a semiconductor intellectual property core, such as a microprocessor core (e.g., embodied in HDL) and transformed to hardware in the production of integrated circuits. Additionally, the system described herein may be embodied as a combination of hardware and software. Thus, the present disclosure should not be limited by any of the above-described exemplary embodiments but should be defined only in accordance with the following claims and their equivalents.

What is claimed is:

1. A method of manufacturing a positive cathode material with a stable olivine structure, comprising:
forming a mixture by combining lithium precursors, iron precursors, and phosphate precursors in an aqueous solution;
adding two different carbon sources to the mixture during mixing process;
evaporating water from the mixture to form a homogeneous precursor mixture; and
annealing the homogeneous precursor mixture to form a carbon-coated lithium iron phosphate cathode material with the stable olivine structure.

2. The method of claim 1, wherein the two different carbon sources comprise sugar and acetylene black.

3. The method of claim 1, wherein the carbon-coated lithium iron phosphate cathode material comprises a homogenous carbon coating in an amorphous form.

4. The method of claim 1, further comprising controlling particle size of the carbon-coated lithium iron phosphate cathode material using a formula based on power and time.

5. The method of claim 1, wherein the carbon-coated lithium iron phosphate cathode material comprises uniform carbon-coated primary particles in a range of 2-15 nm.

6. The method of claim 1, wherein the annealing step results in a single-phase olivine structure with a double amorphous carbon coating.

7. The method of claim 1, wherein the carbon-coated lithium iron phosphate cathode material maintains its olivine structure after cycling at room temperature, as evidenced by X-ray diffraction showing Bragg lines with the same intensity as that of a pristine material.

8. A cathode material for a lithium-iron-phosphate battery, comprising:
lithium iron phosphate particles; and
an amorphous carbon coating on the lithium iron phosphate particles leading to form a carbon-coated lithium iron phosphate cathode material, wherein the amorphous carbon coating is formed using two different carbon sources.

9. A lithium-iron-phosphate battery, comprising:
a cathode comprising the carbon-coated lithium iron phosphate cathode material of claim 8;
an anode; and
an electrolyte, wherein the cathode exhibits a reversible electrode capacity of at least 85% of theoretical capacity when cycled between 2.70 and 4.15 volts vs. Li+/Li at a discharge rate of C/5 at 25° C.

10. The lithium-iron-phosphate battery of claim 9, wherein the cathode exhibits a stable electrochemical performance with less than 3% capacity loss after 50th cycles of charging and discharging of the lithium-iron-phosphate battery.
